(19) United States
(12) Patent Application Publication
(10) Pub. No.: US 2026/0025838 A1
(43) Pub. Date: Jan. 22, 2026

(54) Method and Apparatus for Channel Occupancy Time

(71) Applicant: ZTE CORPORATION, Shenzhen, Guangdong (CN)

(72) Inventors: Yuzhou HU, Shenzhen (CN); Youxiong LU, Shenzhen (CN); Weimin XING, Shenzhen (CN); Jie CHEN, Shenzhen (CN)

(21) Appl. No.: 19/099,972

(22) PCT Filed: Aug. 1, 2022
(86) PCT No.: PCT/CN2022/109548

§ 371 Date: Jan. 30, 2025

(51) Int. Cl. H04W 72/40; H04W 16/14; H04W 72/0446; H04W 72/566

(52) U.S. Cl. CPC H04W 72/40; H04W 72/0446; H04W 72/566; H04W 16/14

(57) ABSTRACT

A wireless communication method for use in a wireless terminal is disclosed. The method comprises transmitting, to a wireless network node, a channel occupancy time (COT) sharing indication associated with sharing a COT initiated by the wireless terminal, wherein the COT sharing indication comprises at least one of: a starting point, a duration or an available resource block set of the COT.

This document is directed generally to wireless communications, and in particular to sidelink (SL) communications.

To perform SL operations in an unlicensed spectrum, it is expected that a user equipment (UE) shall perform transmissions either in a channel occupancy time (COT) dedicated for SL transmissions or alternatively in a COT that can be used presumably for uplink (UL) transmissions or downlink (DL) transmissions of new radio (NR) unlicensed operations.

Regarding new radio (NR) SL operation in a shared channel (SL-U), the UE-to-UE COT sharing is supported and it is expected that type 1 channel access procedures shall be specified to initiate the UE-to-UE COT sharing.

This document relates to methods, systems, and devices for SL communications, and in particular to methods, systems, and devices for COT sharing related to SL communications.

The present disclosure relates to a wireless communication method for use in a wireless terminal. The method comprises transmitting, to a wireless network node, a channel occupancy time (COT) sharing indication associated with sharing a COT initiated by the wireless terminal, wherein the COT sharing indication comprises compromising at least one of: a starting point, a duration or an available resource block set of the COT.

Various embodiments may preferably implement the following features:

Preferably, the COT sharing indication indicates that the COT is unavailable for transmissions from the wireless network node to the wireless terminal and/or from the wireless terminal to the wireless network node.

Preferably, the COT sharing indication indicates that the COT is available for communications with the wireless network node and the method further comprises transmitting, to the wireless network node, an indication associated with slots reserved for sidelink (SL) transmissions in the COT.

Preferably, the indication associated with slots reserved for SL transmissions in the COT comprises at least one of a bitmap associated with slots reserved and/or not reserved for the SL transmissions in the COT, a priority value of each SL transmission in the COT, or a channel access priority class (CAPC) of each SL transmission in the COT.

Preferably, the wireless terminal performs the SL transmissions in the COT by using a resource allocation mode 2.

Preferably, at least one of a bitmap associated with slots reserved for SL transmissions in the COT, a priority value of each SL transmission in the COT, or a CAPC of each SL transmission in the COT is not included in the COT sharing indication

Preferably, the wireless terminal performs sidelink transmissions in the COT by using a resource allocation mode 1

The present disclosure relates to a wireless communication method for use in a wireless network node. The method comprises receiving, from a wireless terminal, a channel occupancy time (COT) sharing indication associated with sharing a COT initiated by the wireless terminal, wherein the COT sharing indication comprises at least one of: a starting point, a duration or an available resource block set of the COT.

Various embodiments may preferably implement the following features:

Preferably, the COT sharing indication indicates that the COT is unavailable for downlink transmissions from the wireless network node to the wireless terminal and/or from the wireless terminal to the wireless network node.

Preferably, the COT sharing indication indicates that the COT is available for communications with the wireless network node and the method further comprises transmitting, to the wireless network node, an indication associated with slots reserved for sidelink (SL) transmissions in the COT.

Preferably, the indication associated with slots reserved for SL transmissions in the COT comprises at least one of a bitmap associated with slots reserved and/or not reserved for the SL transmissions in the COT, a priority value of each SL transmission in the COT, or a channel access priority class (CAPC) of each SL transmission in the COT.

Preferably, the wireless terminal performs the SL transmissions in the COT by using a resource allocation mode 2.

Preferably, at least one of a bitmap associated with slots reserved for SL transmissions in the COT, a priority value of each SL transmission in the COT, or a CAPC of each SL transmission in the COT is not included in the COT sharing indication

Preferably, the wireless terminal performs sidelink transmissions in the COT by using a resource allocation mode 1

The present disclosure relates to a wireless communication method for use in a wireless terminal. The method comprises receiving, from a wireless network node, at least one channel occupancy time (COT) sharing parameter associated with performing a resource allocation mechanism for sharing a COT initiated by the wireless network node with sidelink communications.

Various embodiments may preferably implement the following feature:

Preferably, the at least one COT sharing parameter comprises at least one of a starting point, a duration or an available resource block set of the COT.

The present disclosure relates to A wireless communication method for use in a wireless network node. The method comprises performing a downlink transmission from the wireless network node to a wireless terminal after an uplink transmission and/or a sidelink transmission in a channel occupancy time (COT) initiated for a sidelink transmission by the wireless terminal.

Various embodiments may preferably implement the following features:

Preferably, an energy detection threshold parameter associated with sharing the COT with downlink transmissions from the wireless network node to the wireless terminal is not provided and the downlink transmission does not comprise a unicast transmission having user plane data.

Preferably, an energy detection threshold parameter associated with sharing the COT with downlink transmissions from the wireless network node to the wireless terminal is not provided, and a duration of the downlink transmission is not more than m symbols, where m is a positive integer determined based on a subcarrier spacing of a channel corresponding toa unicast transmission.

Preferably, a gap between the uplink transmission or the sidelink transmission and the downlink transmission is below a threshold and the method further comprises performing a Type 2C downlink channel access procedure for the downlink transmission.

Preferably, a gap between the uplink transmission or the sidelink transmission and the downlink transmission is greater than or equal to a threshold, and the method further comprises performing a Type 2A downlink channel access procedure or a Type 2B downlink channel access procedure for the downlink transmission.

Preferably, an energy detection threshold parameter associated with sharing the COT with downlink transmissions from the wireless network node to the wireless terminal is provided and the method further comprises transmitting, to the wireless terminal, a high layer parameter associated with a table comprising a row which is configured to indicate that the COT sharing is available or unavailable for at least one of an uplink communication or a downlink communication.

Preferably, the wireless communication method further comprises receiving, from the wireless terminal, a COT sharing indication associated with sharing a COT initiated by the wireless terminal, wherein the COT sharing indication indicates at least one COT sharing parameter via the table and the at least one COT sharing parameter comprises at least one of an offset associated with starting sharing the COT, a duration of the COT or a channel access priority class of the downlink transmission.

Preferably, the wireless communication method further comprises:
receiving, from the wireless terminal, a COT sharing indication associated with sharing a COT initiated by the wireless terminal, wherein the row in the table indicated by the COT sharing indication indicates that the COT initiated by the wireless terminal is unavailable for communications between the wireless network node and the wireless terminal, and
initiating a COT for the communications between the wireless network node and the wireless terminal.

The present disclosure relates to wireless communication method for use in a wireless terminal. The method comprises performing a first type of communication with a configured grant on a channel by using a channel access procedure with a first priority class in a channel occupancy time (COT),
wherein a second type of communication on at least part of resource blocks of the channel is scheduled to be performed following the first type of communication by using a channel access procedure without a cyclic prefix extension and with a second priority class in the COT,
wherein, if the first priority class is greater than or equal to the second priority class and a sum of durations of the first type of communication and the second type of communication does not exceed a COT duration associated with the first priority class, the second type of communication is performed after the first type communication without a gap, and
wherein, if the first priority class is smaller than the second priority class, the first type of communication is terminated on the resource blocks occupied by the second type of communication.

Various embodiments may preferably implement the following feature:

Preferably, the first type of communication is one of a sidelink communication and an uplink communication and the second type of communication is another one of the sidelink communication and the uplink communication.

The present disclosure relates to wireless communication method for use in a wireless terminal. The method comprises performing a first type of communication with a configured grant on a channel by using a channel access procedure with a first priority class in a channel occupancy time (COT),
wherein a second type of communication on the same carrier of the channel is scheduled to be performed following the first type of communication by using a channel access procedure without a cyclic prefix extension and with a second priority class in the COT,
wherein, if the first priority class is greater than or equal to the second priority class and a sum of durations of the first type of communication and the second type of communication does not exceed a COT duration associated with the first priority class, the second type of communication is performed by following at least one of:
the second type of communication is performed after the first type communication without a gap, or
only the second type of communication is performed when both the first and second types of communication are scheduled and configured at the same time, and
wherein, if the first priority class is smaller than the second priority class, the first type of communication is terminated on the resource blocks occupied by the second type of communication.

Various embodiments may preferably implement the following feature:

Preferably, the first type of communication is one of a sidelink communication and an uplink communication and the second type of communication is another one of the sidelink communication and the uplink communication.

The present disclosure relates to a wireless communication method for use in a wireless terminal. The method comprises performing a channel access procedure for a first type of communication and/or a second type of communication in a channel occupancy time initiated for the first type of communication and/or the second type of communication, wherein at least one channel availability detecting parameter of the channel access procedure is determined based on the at least one channel availability detecting parameter associated with the first type of communication and the at least one channel availability detecting parameter associated with the second type of communication.

Various embodiments may preferably implement the following features:

Preferably, the at least one channel availability detecting parameter comprises an energy detection threshold associated with determining an idle status and/or a busy status of a channel and the energy detection threshold of the channel access procedure is set as one of a minimum, an average, or a maximum between the energy detection threshold associated with the first type of communication and the energy detection threshold associated with the second type of communication.

Preferably, the at least one channel availability detecting parameter comprises a congestion window length associated with determining an availability of a channel and the congestion window length of the channel access procedure is set as one of a maximum, an average, or a minimum between the congestion window length associated with the first type of communication and the congestion window length associated with the second type of communication.

Preferably, the first type of communication is one of a sidelink communication and an uplink communication and the second type of communication is another one of the sidelink communication and the uplink communication.

The present disclosure relates to a wireless communication method for used in a wireless terminal. The method comprises receiving, from a wireless network node, a high layer signaling associated with a configuration or a pre-configuration of whether a first type of communication is allowed in a channel occupancy time initiated by the wireless terminal for a second type of communication.

Various embodiments may preferably implement the following feature:

Preferably, the first type of communications is one of a sidelink communication and a communication with the wireless network node and the second type of communication is another one of the sidelink communication and the communication with the wireless network node, wherein the communication with the wireless network node comprises at least one of an uplink communication or a downlink communication.

The present disclosure relates to a wireless communication method for used in a wireless network node. The method comprises transmitting, to a wireless terminal, a high layer signaling associated with a configuration or a pre-configuration of whether a first type of communication is allowed in a channel occupancy time initiated by the wireless terminal for a second type of communication.

Various embodiments may preferably implement the following feature:

Preferably, the first type of communications is one of a sidelink communication and a communication with the wireless network node and the second type of communication is another one of the sidelink communication and the communication with the wireless network node, wherein the communication with the wireless network node comprises at least one of an uplink communication or a downlink communication.

The present disclosure relates to a wireless terminal. The wireless terminal comprises:
a communication unit, configured to transmit, to a wireless network node, a channel occupancy time (COT) sharing indication associated with sharing a COT initiated by the wireless terminal, wherein the COT sharing indication comprises at least one of: a starting point, a duration or an available resource block set of the COT.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, configured to receive, from a wireless terminal, a channel occupancy time (COT) sharing indication associated with sharing a COT initiated by the wireless terminal, wherein the COT sharing indication comprises at least one of: a starting point, a duration or an available resource block set of the COT.

Various embodiments may preferably implement the following feature:

Preferably, the wireless network node further comprises a processor configured to perform any of aforementioned wireless communication methods.

The present disclosure relates to a wireless terminal. The wireless terminal comprises:
a communication unit, configured to receive, from a wireless network node, at least one channel occupancy time (COT) sharing parameter associated with performing a resource allocation mechanism for sharing a COT initiated by the wireless network node with sidelink communications.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, and
a processor, configured to perform a downlink transmission from the wireless network node to a wireless terminal after an uplink transmission and/or a sidelink transmission in a channel occupancy time (COT) initiated for a sidelink transmission by the wireless terminal.

Various embodiments may preferably implement the following feature:

Preferably, the processor is further configured to perform any of aforementioned wireless communication methods.

The present disclosure relates to a wireless terminal. The wireless terminal comprises:
a communication unit, and
a processor, configured to perform a first type of communication with a configured grant on a channel by using a channel access procedure with a first priority class in a channel occupancy time (COT),
wherein a second type of communication on at least part of resource blocks of the channel is scheduled to be performed following the first type of communication by using a channel access procedure without a cyclic prefix extension and with a second priority class in the COT,
wherein, if the first priority class is greater than or equal to the second priority class and a sum of durations of the first type of communication and the second type of communication does not exceed a COT duration associated with the first priority class, the second type of communication is performed after the first type communication without a gap, and
wherein, if the first priority class is smaller than the second priority class, the first type of communication is terminated on the resource blocks occupied by the second type of communication.

Various embodiments may preferably implement the following feature:

Preferably, the processor is further configured to perform any of aforementioned wireless communication methods.

The present disclosure relates to a wireless terminal. The wireless terminal comprises:
a communication unit, and
a processor, configured to perform a first type of communication with a configured grant on a channel by using a channel access procedure with a first priority class in a channel occupancy time (COT),
wherein a second type of communication on the same carrier of the channel is scheduled to be performed following the first type of communication by using a channel access procedure without a cyclic prefix extension and with a second priority class in the COT,
wherein, if the first priority class is greater than or equal to the second priority class and a sum of durations of the first type of communication and the second type of communication does not exceed a COT duration associated with the first priority class: the second type of communication is performed by following at least one of:
the second type of communication is performed after the first type communication without a gap, or
only the second type of communication is performed when both the first and second communication are scheduled and configured at the same time, and
wherein, if the first priority class is smaller than the second priority class, the first type of communication is terminated on resource blocks occupied by the second type of communication.

Various embodiments may preferably implement the following feature:

Preferably, the processor is further configured to perform any of aforementioned wireless communication methods.

The present disclosure relates to a wireless terminal. The wireless terminal comprises:
a communication unit, and
a processor, configured to perform a channel access procedure for a first type of communication and/or a second type of communication in a channel occupancy time initiated for the first type of communication and/or the second type of communication,
wherein at least one channel availability detecting parameter of the channel access procedure is determined based on the at least one channel availability detecting parameter associated with the first type of communication and the at least one channel availability detecting parameter associated with the second type of communication.

Various embodiments may preferably implement the following feature:

Preferably, the processor is further configured to perform any of aforementioned wireless communication methods.

The present disclosure relates to a wireless terminal. The wireless terminal comprises:
a communication unit, configured to receive, from a wireless network node, a high layer signaling associated with a configuration or a pre-configuration of whether a first type of communication is allowed in a channel occupancy time initiated by the wireless terminal for a second type of communication.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, configured to transmit, to a wireless terminal, a high layer signaling associated with a configuration or a pre-configuration of whether a first type of communication is allowed in a channel occupancy time initiated by the wireless terminal for a second type of communication.

Various embodiments may preferably implement the following feature:

Preferably, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

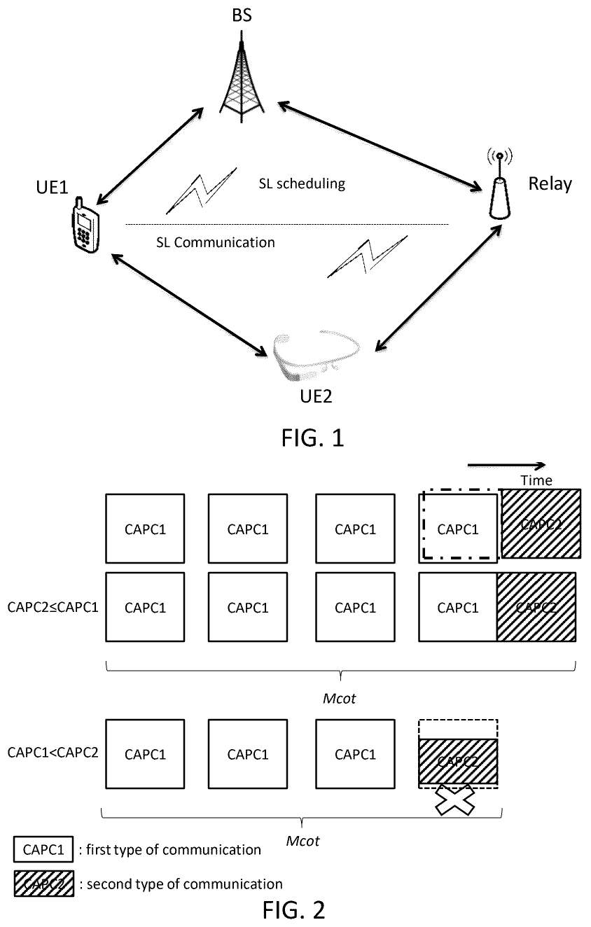

FIG. 1 shows a schematic diagram of a network (architecture) according to an embodiment of the present disclosure.

FIG. 2 shows a schematic diagram of communications in COT according to an embodiment of the present disclosure.

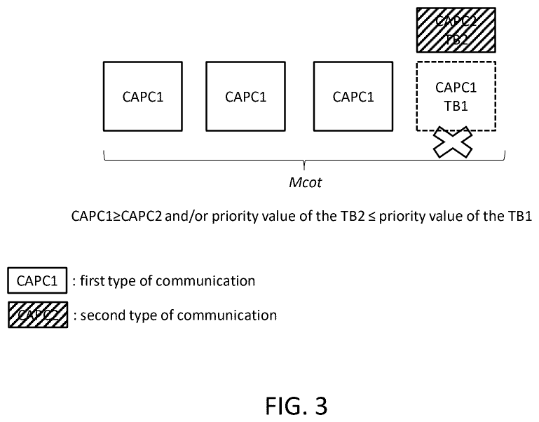

FIG. 3 shows a schematic diagram of communications in COT according to an embodiment of the present disclosure.

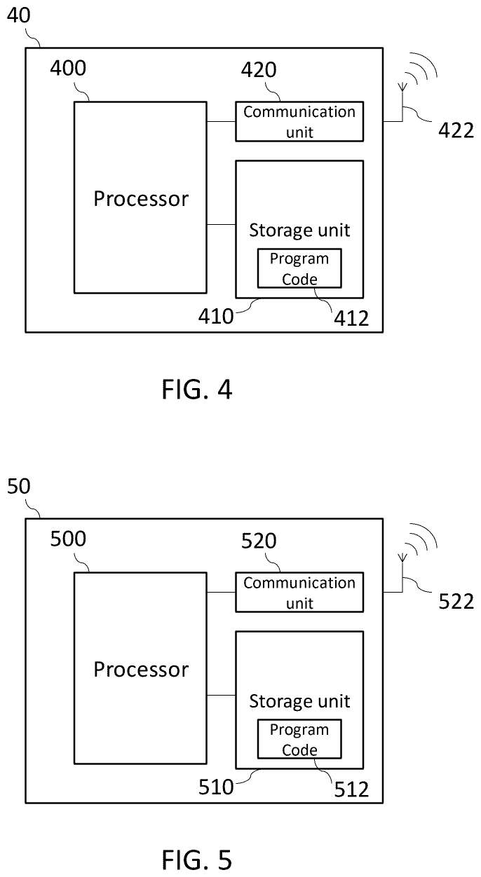

FIG. 4 shows an example of a schematic diagram of a wireless terminal according to an embodiment of the present disclosure.

FIG. 5 shows an example of a schematic diagram of a wireless network node according to an embodiment of the present disclosure.

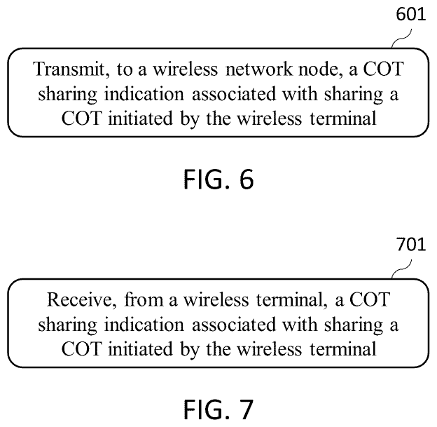

FIGS. 6 to 15 show flowcharts of methods according to embodiments of the present disclosure.

FIG. 1 shows a schematic diagram of a network (architecture) according to an embodiment of the present disclosure. The network shown in FIG. 1 comprises a base station (BS), a relay (node) (e.g., a header UE) and two UEs, UE1 and UE2. For example, the UE1 may be a mobile phone and the UE2 may be a smart gadget (e.g., smart glasses). As an alternative, the UE1 and/or UE2 may be an internet of things (IoT) device. The UE1 and/or UE2 may communicate with the BS directly or via relay. Based on a SL scheduling received from the BS, the relay, UE1 and UE2 may communicate with each other, where the communication between every two of the relays, UE1 and UE2 are called SL communications. The SL communication may be in the form of unicast, groupcast or broadcast. Furthermore, the UE2 may communicate with the BS/relay via the UE1. That is the UE1 may act as a UE/mobile relay.

In the present disclosure, the COT may refer to channel occupancy and vice versa.

In some embodiments associated with SL unlicensed operations, the base station (BS) (e.g., eNB, gNB radio access network (RAN) node) does not perform a Type 1 channel access (procedure) to initiate and share a channel occupancy. In addition, the BS performs neither a Type 2 channel access (procedure) (e.g., Type 2A/2B/2C channel access (procedure)) to share an initiated channel occupancy nor semi-static channel access procedures to access an unlicensed channel.

In some embodiments, the Type 1 and Type 2 channel access procedures and/or transmission gap and listen-before-talk (LBT) sensing idle time requirements specified for NR-U are taken as a baseline for NR SL operation in a shared channel (SL-U).

In some embodiments, the BS needs to perform a Type 2A channel access (procedure) following a UL transmission for a (DL) transmission, wherein the Type 2A channel access is initiated at least 25 microseconds in advance of the corresponding (DL) transmission.

In some embodiments, the BS needs to perform a Type 2B/2C channel access (procedure) following a UL transmission for a (DL) transmission, wherein the Type 2B/2C channel access is initiated up to 16 microseconds before the corresponding (DL) transmission.

In some embodiments, the following use cases are relevant in terms of which DL transmission can take up a UE initiated COT for UL transmissions.

In an embodiment, the BS shares a channel occupancy initiated by a UE, the BS may transmit/perform a (DL) transmission that follows an autonomous physical UL shared channel (PUSCH) transmission from the UE as follows:
If ‘COT sharing indication’ in Autonomous-Uplink UL control information (AUL-UCI) in a subframe n indicates ‘1’, the BS may transmit a transmission in a subframe n+X, where X is an offset subframeOffsetCOT-Sharing. The transmission includes a physical DL control channel (PDCCH) but not including physical DL shared channel (PDSCH) on the same channel immediately after performing the Type 2A DL channel access procedures if the duration of the PDCCH is less than or equal to the duration of two OFDM symbols and the PDCCH contains/comprises at least AUL DL feedback information (AUL-DFI) or a UL grant to the UE from which the PUSCH transmission indicating COT sharing was received.

In an embodiment, if a BS shares a channel occupancy initiated by a UE using a TYPE 1 UL channel access procedures on a channel, the BS may transmit a transmission that follows a UL transmission on scheduled resources or a PUSCH transmission on configured resources by the UE after a gap as follows:
the transmission contains/comprises transmission to the UE that initiated the channel occupancy and may include non-unicast and/or unicast transmissions where any unicast transmission that includes user plane data is only transmitted to the UE that initiated the channel occupancy.
if a higher layer parameter ul-toDL-COT-SharingED-Threshold-r16 is not provided, the transmission does not include any unicast transmission with user plane data and the transmission duration is not more than the duration of 2, 4 and 8 symbols for subcarrier spacing of 15, 30 and 60 kHz of the corresponding channel, respectively.
if the gap is up to 16 microseconds, the BS may transmit the transmission on the channel after performing a Type 2C DL channel access (procedure).
If the gap is 25 microseconds or 16 microseconds, the BS may transmit the transmission on the channel after performing a Type 2A or Type 2B DL channel access procedure.

In an embodiment, a BS shares a channel occupancy initiated by a UE having a configured grant PUSCH transmission. In this embodiment, the gNB may transmit a transmission that follows the configured grant PUSCH transmission from the UE as follows:
If the higher layer parameter ul-toDL-COT-SharingED-Threshold-r16 is provided, the UE is configured by cg-COT-SharingList-r16, where the cg-COT-SharingList-r16 provides a table configured by a higher layer (i.e., a layer higher than physical layer) and each row of the table provides channel occupancy sharing information given by a higher layer parameter CG-COT-Sharing-r16. In addition, one row of the table is configured for indicating that the channel occupancy sharing is not available.
If the ‘COT sharing information’ in CG-UCI detected in a slot n indicates a row index that corresponds to a CG-COT-Sharing-r16 providing the channel occupancy sharing information, the BS may share the UE initiated channel occupancy by assuming that a channel access priority class (CAPC) p is equal to channel AccessPriority-r16 and that the channel occupancy starts from a slot n+O (where O=offset-r16 slots) for a duration of D=duration-r16 slots. Note that duration-r16, offset-r16, and channelAccessPriority-r16 are higher layer parameters provided by the CG-COT-Sharing-r16.
If the higher layer parameter ul-toDL-COT-SharingED-Threshold-r16 is not provided, and if ‘COT sharing information’ in CG-UCI indicates ‘l’, the gNB may share the UE initiated channel occupancy and start the DL transmission after X=cg-COT-SharingOffset-r16*14 symbols from the end of the slot where CG-UCI (configured grant UCI) is detected, where cg-COT-SharingOffset-r16 is provided by a higher layer. The transmission may not include any unicast transmissions with user plane data and the transmission duration is not more than the duration of 2, 4 and 8 symbols for subcarrier spacing of 15, 30 and 60 KHz of the corresponding channel, respectively.

In some embodiments, the following are applicable for UL transmission(s) following configured grant UL transmission(s):
If a UE is scheduled to transmit UL transmission(s) starting from a symbol i in a slot n by using Type 1 channel access procedures without cyclic prefix (CP) extension with a corresponding channel access priority class (CAPC), if the UE starts the configured grant UL transmissions before the symbol i in the slot n by using Type 1 channel access procedures with a corresponding CAPC, and if the scheduled UL transmission(s) occupies all the resource blocks (RBs) of the same channels occupied by the configured grant UL transmission(s) or all the RBs of a subset thereof, the UE may directly continue to transmit the scheduled UL transmission(s) to the corresponding CAPC from the symbol i in the slot n without a gap if the CAPC value of the performed channel access procedure is larger than or equal to the CAPC value corresponding to the scheduled UL transmission(s). The sum of the transmission durations of the configured grant UL transmission(s) and the scheduled UL transmission(s) may not exceed the maximum COT (MCOT) duration corresponding to the CAPC value used to transmit the configured grant UL transmission(s). Otherwise, the UE terminates the configured grant UL transmission(s) by dropping the transmission on the symbols of at least the last configured grant UL transmission before the symbol i in the slot n and attempts to transmit the scheduled UL transmission(s) according to the corresponding CAPC.

In some embodiments, the symbols of the PUSCH transmission with a configured grant in a slot is dropped according to mechanism of a UE procedure for determining slot format, which is relative to a last symbol of a control resource set (CORESET) where the UE detected the scheduling DCI. In these embodiments, the UE ignores the scheduling DCI if the UE cannot terminate the configured grant UL transmission(s).

In some embodiments, the following cases associated with the COT sharing may be allowed/enabled:
a UE initiates a COT for NR-U and shares the initiated COT to SL communications,
a UE initiates a COT for SL-U and passes the COT to a BS (e.g., gNB) and the BS transfers the COT to SL UE communications,
a UE initiates a COT for SL-U and passes the COT to a BS, e.g., a gNB, and the BS uses the COT for NR-U transmissions,
a UE initiates a COT for NR-U transmissions and passes the COT to the BS via a control link of SL and the BS transfers the COT to SL UE communications.

In some embodiments, to enable the SL transmission to share a UE initiated COT, the UE indicates, via the UCI, (uplink control information), e.g., CG-UCI, that the (UE initiated) COT is not available for BS transmission (e.g. NR-U transmissions from the BS to the UE and/or DL transmissions).

In some embodiments, to enable the SL transmission to share a UE initiated COT in case that the UE indicates via the UCI that the (UE initiated) COT is available for gNB transmissions, a bitmap field indicating the actually reserved and/or not reserved (i.e., unreserved) SL transmissions is indicated in the UCI. In these embodiments, the DL and/or UL transmissions get started from the most recent DL and/or UL slot and/or symbol which excludes those reserved for the SL transmissions indicated by the bitmap and is not earlier than n+O slots, wherein the UCI comprising the bitmap field is received by the BS in a slot n and O is an offset value preconfigured and/or configured by the higher layer. The DL and/or UL transmission may occupy the resources within a duration D excluding the SL slots indicated by the bitmap. The duration D may be configured and/or preconfigured by the higher layer.

In some embodiments, to enable the SL UE to share a gNB initiated COT, the BS may transmit DL control information (DCI) to the SL UE to indicate the COT sharing information which includes an enabling of the COT to be used for SL transmissions and is associated with the SL UE performing mode 1 or mode 2 resource allocation mechanism. In the mode 1 resource allocation mechanism for PSSCH (physical SL shared channel) and PSCCH (physical SL control channel) transmissions, the BS scheduling including dynamic grant, configured grant type 1 and configured grant type 2 are supported. In the mode 2 resource allocation mechanism, the higher layer may request the UE to determine a subset of resources from which the higher layer will select resources for the PSSCH/PSCCH transmissions. To trigger this procedure, in a slot n, the higher layer provides at least the resource pool index, a remaining packet delay budget (PDB) and L1 priority etc. for this PSSCH/PSCCH transmission.

In an embodiment, the COT sharing information includes the information associated with at least one of a starting point of the COT, COT duration, available RB set of COT, etc.

In some embodiments, pre-configured RRC parameters associated with an energy detection threshold (e.g., sl-toDL-COT-SharingED-Threshold-r16) and the COT sharing indicator (e.g., sl-cg-COT-Sharing from an RRC list sl-cg-COT-SharingList-r16 for sidelink transmission) may function as at least one of the following:
If the higher layer parameters (e.g., sl-toDL-COT-SharingED-Threshold-r16) is not provided, the DL transmission does/shall not include any unicast transmission with user plane data and the transmission duration is not more than the duration of 2, 4 and 8 symbols for subcarrier spacing of 15, 30 and 60 KHz of the corresponding channel, respectively.
If a gap is up to 16 microseconds, the gNB transmits the transmission on the channel (in the gap) after performing a Type 2C DL channel access procedure, wherein the gap is between a scheduled UL and/or SL transmission in the COT.
If a gap is 25 microseconds or 16 microseconds, the gNB can transmit the transmission on the channel (in the gap) after performing a Type 2A or Type 2B DL channel access procedure, wherein the gap is between a scheduled UL and/or SL transmission in the COT.
If the higher layer parameter sl-toDL-COT-SharingED-Threshold-r16 is provided, the UE is configured by sl-cg-COT-SharingList-r16 where sl-cg-COT-SharingList-r16 provides a table configured by higher layer. Each row of the table provides a channel occupancy sharing information given by higher layer parameter sl-CG-COT-Sharing-r16. One row of the table is configured for indicating that the channel occupancy sharing is not available for gNB transmission. One row of the table is configured for indicating that the channel occupancy sharing is not available for UL transmission. One row of the table is configured for indicating that the channel occupancy sharing is not available for UL or DL transmission.
If the ‘COT sharing information’ in CG-UCI detected in slot n indicates a row index that corresponds to a sl-CG-COT-Sharing-r16 providing channel occupancy sharing information, the gNB can share the UE channel occupancy by assuming that a channel access priority class p=channelAccessPriority-r16 and that the UE channel occupancy starts from slot n+O, where O-offset-r16 slots, for a duration of D=duration-r16 slots, where duration-r16, offset-r16, and channelAccessPriority-r16 are higher layer parameters provided by sl-CG-COT-Sharing-r16.
If the higher layer parameter sl-toDL-COT-SharingED-Threshold-r16 is not provided, and if ‘COT sharing information’ in CG-UCI indicates ‘1’, the gNB can share the UE channel occupancy and start the DL transmission X=sl-cg-COT-SharingOffset-r16*14 symbols from the end of the slot where CG-UCI is detected, where sl-cg-COT-SharingOffset-r16 is provided by higher layer. The transmission shall not include any unicast transmissions with user plane data and the transmission duration is not more than the duration of 2, 4 and 8 symbols for subcarrier spacing of 15, 30 and 60 kHz of the corresponding channel, respectively.

In some embodiments, the row in the list sl-cg-COT-SharingList-r16 is configured as not available for UL transmission. In these embodiments, the DL and/or UL transmissions get started from the most recent DL and/or UL slot and/or symbol which excludes those reserved for the SL transmissions indicated by the bitmap and is not earlier than n+O slots, wherein the UCI comprising the bitmap field is received by the BS in a slot n and O is an offset value preconfigured and/or configured by the higher layer. The DL and/or UL transmission may occupy the resources within a duration D excluding the SL slots indicated by the bitmap. The duration D may be configured and/or preconfigured by the higher layer.

In some embodiments, the row of the table may be preconfigured or configured to indicate that the channel occupancy sharing is not available for UL and/or DL transmission. In these embodiments, the BS and/or the UE may initiate another COT share (only) for NR-U DL and/or UL transmission.

In some embodiments, at least one of the following rules are applicable for SL transmission(s) following configured grant UL transmission(s), UL transmission(s) following configured grant SL transmission(s), and/or SL transmission(s) following configured grant SL transmission(s):
If a UE is scheduled to transmit SL and/or UL transmission(s) starting from symbol i in slot n using Type 1 channel access procedures without CP extension with a corresponding CAPC, and if the UE starts configured grant UL and/or SL transmissions before symbol i in slot n using Type 1 channel access procedures with a corresponding CAPC, and the scheduled SL and/or UL transmission(s) occupies all the RBs of the same channels occupied by the configured grant UL transmission(s) or all the RBs of a subset thereof, the UE may directly continue to transmit the scheduled SL and/or UL transmission(s) to the corresponding CAPC from symbol i in slot n without a gap, if the CAPC value of the performed channel access procedure is larger than or equal to the CAPC value corresponding to the scheduled SL and/or UL transmission(s). The sum of the transmission durations of the configured grant UL and/or SL transmission(s) and the scheduled SL and/or UL transmission(s) shall not exceed the MCOT duration corresponding to the CAPC value used to transmit the configured grant UL and/or SL transmission(s).
Otherwise, the UE shall terminate the configured grant UL and/or SL transmission(s) by dropping the transmission on the symbols of at least the last configured grant UL and/or SL transmission before symbol i in slot n and attempt to transmit the scheduled SL and/or UL transmission(s) according to the corresponding CAPC. The symbols of the PUSCH/PSSCH transmission with a configured grant in a slot is dropped after at least a certain preparation time relative to a last symbol of a CORESET where the UE detected the scheduling DCI. In this case, if the UE cannot terminate the configured grant UL and/or transmission(s), the UE ignores the scheduling DCI.

FIG. 2 shows a schematic diagram of communications in the COT according to an embodiment of the present disclosure. In FIG. 2, the UE performs a first type of communication with a configured grant and is scheduled to perform a second type of communication following or overlapping the first type of communication by using the Type 1 channel access procedure without a CP extension. The first type of communication has a priority value (e.g., CAPC) CAPC1 and the second type of communication has a priority value (e.g., CAPC2), The first type of communication is one of a SL transmission and a UL transmission and the second type of communication is another one of the SL transmission and the UL transmission. As shown in FIG. 2, the second type of communication occupies a part of RBs of the same channels occupied by the first type of communication. If CAPC1 is greater than or equal to CAPC2, the UE performs the second type of communication after the first type of communication without a gap.

If CAPC1 is smaller than CAPC2, the UE terminates the first type of communication in and performs the second type of communication in the RBs occupied by the second type of communication.

In some embodiments, at least one of the following rules are applicable for SL and/or UL transmission(s) following configured grant UL and/or SL transmission(s):
If a UE is scheduled to transmit SL and/or UL transmission(s) starting from symbol i in slot n using Type 1 channel access procedures without CP extension with a corresponding CAPC, and if the UE starts configured grant UL and/or SL transmissions before and/or at symbol i in slot n using Type 1 channel access procedures with a corresponding CAPC, and the scheduled SL and/or UL transmission(s) occupies all the RBs of the same channels occupied by the configured grant UL transmission(s), all the RBs of a subset thereof or on some channel(s) in the same carrier as the configured grant UL and/or SL transmissions, the UE may directly transmit the scheduled SL and/or UL transmission(s) to the corresponding CAPC from symbol i in slot n without a gap, if the CAPC value of the performed channel access procedure is larger than or equal to the CAPC value corresponding to the scheduled SL and/or UL transmission(s) and/or the priority of the TB of the configured grant UL and/or SL transmissions is larger than or equal to the priority of the TB of the scheduled SL and/or UL transmissions. The sum of the transmission durations of the configured grant UL and/or SL transmission(s) and the scheduled SL and/or UL transmission(s) shall not exceed the MCOT duration corresponding to the CAPC value used to transmit the configured grant UL and/or SL transmission(s).
Otherwise, the UE shall terminate the configured grant UL and/or SL transmission(s) by dropping the transmission on the symbols of at least the last configured grant UL and/or SL transmission before symbol i in slot n and attempt to transmit the scheduled SL and/or UL transmission(s) according to the corresponding CAPC. The symbols of the PUSCH/PSSCH transmission with a configured grant in a slot is dropped after at least a certain preparation time relative to a last symbol of a CORESET where the UE detected the scheduling DCI. In this case, if the UE cannot terminate the configured grant UL and/or transmission(s), the UE ignores the scheduling DCI.

FIG. 3 shows a schematic diagram of communications in the COT according to an embodiment of the present disclosure. In FIG. 3, the UE performs a first type of communication with a configured grant and is scheduled to perform a second type of communication following the first type of communication by using the Type 1 channel access procedure without a CP extension. The first type of communication has a priority value (e.g., CAPC) CAPC1 and the second type of communication has a priority value (e.g., CAPC2). The first type of communication is one of a SL transmission and a UL transmission and the second type of communication is another one of the SL transmission and the UL transmission. In FIG. 3, the second type of communication is in the same carrier as the first type of communication and may occupy the same or different channels from the first type of communication. In this embodiment, the UE performs only the second type of communication because CAPC1 is greater than or equal to CAPC2 and/or a priority value of a transport block TB1 of the first type of communication is greater than or equal to that of a transport block TB2 of the second type of communication.

In some embodiments, an idle status criterion and/or a busy status criterion applied in a channel access procedure is the minimum of the energy detection thresholds for SL and UL operations, such that the COT can be shared by both SL and UL transmissions.

In some embodiments, a congestion window applied in a channel access procedure is set as the maximum of the congestion windows of SL and UL transmissions, to allow the COT to be shared by both SL and UL transmissions.

In some embodiments, whether SL transmission can take up UL COT, or UL/DL communication can take up SL COT can be (pre-)configured as enabled or disabled. That is, the UE may be (pre-)configured to allow the SL transmission to use an UL COT and/or the UL/DL communication to use an SL COT, e.g., by a higher layer signaling (e.g., RRC signaling).

In some embodiments, the UE does not indicate certain COT parameter(s) of the UE initiated COT to the BS. For example, the UE may not indicate at least the UE initiated COT duration to the BS for the mode 1 transmission(s).

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 410 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

FIG. 5 relates to a schematic diagram of a wireless network node 50 according to an embodiment of the present disclosure. The wireless network node 50 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g., messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g. a user equipment or another wireless network node).

FIG. 6 shows a flowchart of a method according to an embodiment of the present disclosure. The method shown in FIG. 6 may be used in a wireless terminal (e.g., UE) and comprises the following step:
Step 601: Transmit, to a wireless network node, a COT sharing indication associated with sharing a COT initiated by the wireless terminal.

In this embodiment, the wireless terminal may share a COT initiated by itself with various types of communication. Under such a condition, the wireless terminal transmits a COT sharing indication associated with sharing the COT initiated by the wireless terminal to the wireless network node. In this embodiment, the COT sharing indication comprises at least one of a starting point, a duration or an available resource block set of the COT.

In an embodiment, the COT sharing indication indicates that the COT is unavailable for transmissions from the wireless network node to the wireless terminal and/or from the wireless terminal to the wireless network node, e.g., to enable SL transmissions to share the COT initiated by the wireless terminal.

In an embodiment, the COT sharing indication indicates that the COT is available for communications (i.e., UL and/or DL transmission) with the wireless network node, e.g., to enable SL transmission to share the COT initiated by the wireless terminal. In this embodiment, the wireless terminal transmits an indication associated with slots reserved for the SL transmissions in the COT to the wireless network node. For example, the indication associated with the slots reserved for the SL transmissions in the COT may comprises at least one of:
a bitmap associated with slots reserved and/or not reserved for the SL transmissions in the COT,
a priority value of each SL transmission in the COT, or
a CAPC of each SL transmission in the COT.

In an embodiment, the wireless terminal performs the SL transmissions in the COT by using a resource allocation mode 2.

In an embodiment, at least one of a bitmap associated with slots reserved and/or not reserved for the SL transmissions in the COT, a priority value of each SL transmission in the COT, or a CAPC of each SL transmission in the COT is not included in the COT sharing indication. In this embodiment, the wireless terminal may perform the SL by using a resource allocation mode 1.

FIG. 7 shows a flowchart of a method according to an embodiment of the present disclosure. The method shown in FIG. 7 may be used in a wireless network node and comprises the following step:
Step 701: Receive, from a wireless terminal, a COT sharing indication associated with sharing a COT initiated by the wireless terminal.

In FIG. 7, the wireless network node receives a COT sharing indication from the wireless terminal. The COT sharing indication is associated with sharing a COT initiated by the wireless terminal. For example, the COT sharing indication comprises at least one of a starting point, a duration or and available resource block set of the COT.

In an embodiment, the COT sharing indication indicates that the COT is unavailable for transmissions from the wireless network node to the wireless terminal and/or from the wireless terminal to the wireless network node, e.g., to enable SL transmissions to share the COT initiated by the wireless terminal.

In an embodiment, the COT sharing indication indicates that the COT is available for communications with the wireless network node, e.g., to enable SL transmission to share the COT initiated by the wireless terminal. In this embodiment, the wireless terminal transmits an indication associated with slots reserved for the SL transmissions in the COT to the wireless network node. For example, the indication associated with the slots reserved for the SL transmissions in the COT may comprises at least one of:
a bitmap associated with slots reserved and/or not reserved for the SL transmissions in the COT,
a priority value of each SL transmission in the COT, or
a CAPC of each SL transmission in the COT.

In an embodiment, the wireless terminal performs the SL transmissions in the COT by using a resource allocation mode 2.

In an embodiment, at least one of a bitmap associated with slots reserved and/or not reserved for the SL transmissions in the COT, a priority value of each SL transmission in the COT, or a CAPC of each SL transmission in the COT is not included in the COT sharing indication. In this embodiment, the wireless terminal may perform the SL by using a resource allocation mode 1.

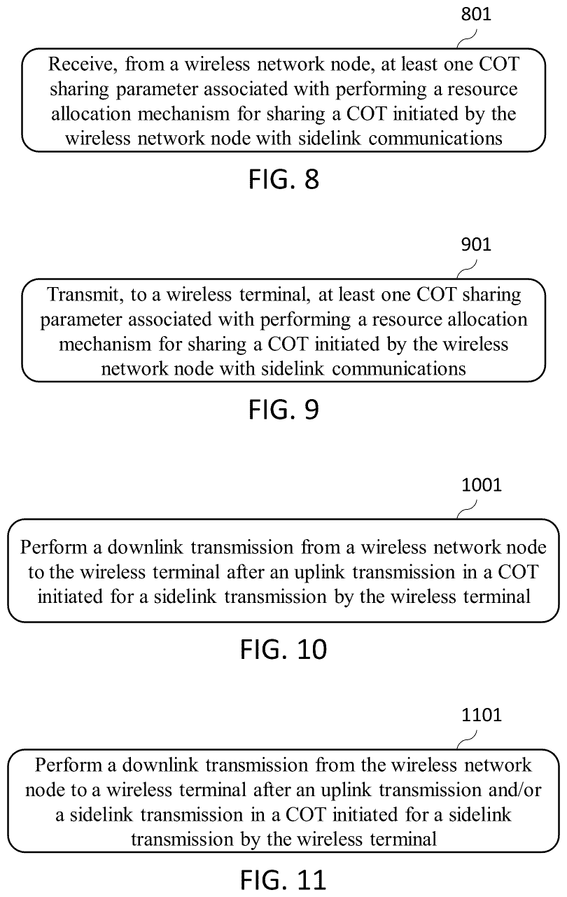

FIG. 8 shows a flowchart of a method according to an embodiment of the present disclosure. The method shown in FIG. 8 may be used in a wireless terminal and comprises the following step:
Step 801: Receive, from a wireless network node, at least one COT sharing parameter associated with performing a resource allocation mechanism for sharing a COT initiated by the wireless network node with sidelink communications.

In this embodiment, the wireless terminal receives at least one COT sharing parameter from a wireless network node. The at least one COT sharing parameter is associated with performing a resource allocation mechanism for sharing a COT initiated by the wireless network node with sidelink communications.

In an embodiment, the at least one COT sharing parameter comprises at least one of a starting point, a duration or an available resource block set of the COT.

FIG. 9 shows a flowchart of a method according to an embodiment of the present disclosure. The method shown in FIG. 9 may be used in a wireless network node and comprises the following step:
Step 901: Transmit, to a wireless terminal, at least one COT sharing parameter associated with performing a resource allocation mechanism for sharing a COT initiated by the wireless network node with sidelink communications.

In this embodiment, the wireless network node transmits at least one COT sharing parameter to a wireless terminal. The at least one COT sharing parameter is associated with performing a resource allocation mechanism for sharing a COT initiated by the wireless network node with sidelink communications.

In an embodiment, the at least one COT sharing parameter comprises at least one of a starting point, a duration or an available resource block set of the COT.

FIG. 10 shows a flowchart of a method according to an embodiment of the present disclosure. The method shown in FIG. 10 may be used in a wireless terminal and comprises the following step:
Step 1001: Perform a downlink transmission from a wireless network node to the wireless terminal after an uplink transmission in a COT initiated for a sidelink transmission by the wireless terminal.

In this embodiment, the wireless terminal performs a DL transmission (i.e. from a wireless network node to the wireless terminal) after a UL transmission in a COT initiated for an SL transmission by the wireless terminal.

In an embodiment, an energy detection threshold parameter associated with sharing the COT with DL transmissions from the wireless network node to the wireless terminal (e.g., sl-toDL-COT-SharingED-Threshold-r16) is not provided. In this embodiment, the DL transmission does not comprise a unicast transmission having user plane data. As an alternative or in addition, a duration of the DL transmission is not more than m symbols, where m is a positive integer determined based on a subcarrier spacing of a channel corresponding to unicast transmissions.

In an embodiment, a gap between the UL transmission and the DL transmission is below a threshold (e.g., 16 microseconds). Under such a condition, the wireless terminal performs a Type 2C downlink channel access procedure for the DL transmission.

In an embodiment, a gap between the UL transmission and the DL transmission is greater than or equal to a threshold (e.g., 16 microseconds or 25 microseconds) In this embodiment, the wireless terminal performs a Type 2A downlink channel access procedure or a Type 2B downlink channel access procedure for the DL transmission.

In an embodiment, an energy detection threshold parameter associated with sharing the COT with DL transmissions from the wireless network node to the wireless terminal (e.g., sl-toDL-COT-SharingED-Threshold-r16) is provided. In this embodiment, the wireless terminal may receive, from the wireless network node, a high layer parameter (e.g., cg-COT-SharingList-r16) associated with a table comprising a row which is configured to indicate that the COT sharing is available or unavailable for at least one of an UL communication or a DL communication.

In an embodiment, the wireless terminal transmits a COT sharing indication associated with sharing a COT initiated by the wireless terminal to the wireless network node. Note that the COT sharing indication indicates at least one COT sharing parameter via the table and the at least one COT sharing parameter comprises at least one of an offset associated with starting sharing the COT, a duration of the COT or a channel access priority class of the DL transmission.

In an embodiment, the wireless terminal transmits a COT sharing indication associated with sharing a COT initiated by the wireless terminal to the wireless network node. In this embodiment, the row in the table indicated by the COT sharing indication indicates that the COT initiated by the wireless terminal is unavailable for communications between the wireless network node and the wireless terminal. Under such conditions, the wireless terminal initiates a COT for the communications between the wireless network node and the wireless terminal.

FIG. 11 shows a flowchart of a method according to an embodiment of the present disclosure. The method shown in FIG. 11 may be used in a wireless network node and comprises the following step:
Step 1101: Perform a downlink transmission from the wireless network node to a wireless terminal after an uplink transmission and/or a sidelink transmission in a COT initiated for a sidelink transmission by the wireless terminal.

In this embodiment, the wireless network node performs a DL transmission (i.e., from the wireless network node to a wireless terminal) after an uplink transmission and/or an SL transmission in a COT initiated for an SL transmission by the wireless terminal.

In an embodiment, an energy detection threshold parameter associated with sharing the COT with DL transmissions from the wireless network node to the wireless terminal (e.g., sl-toDL-COT-SharingED-Threshold-r16) is not provided. In this embodiment, the DL transmission does not comprise a unicast transmission having user plane data. As an alternative or in addition, a duration of the DL transmission is not more than m symbols, where m is a positive integer determined based on a subcarrier spacing of a channel corresponding to unicast transmissions.

In an embodiment, a gap between the UL transmission or the SL transmission and the DL transmission is below a threshold (e.g., 16 microseconds). Under such a condition, the wireless network node performs a Type 2C downlink channel access procedure for the DL transmission.

In an embodiment, a gap between the UL transmission or the SL transmission and the DL transmission is greater than or equal to a threshold (e.g., 16 microseconds or 25 microseconds) In this embodiment, the wireless network node performs a Type 2A downlink channel access procedure or a Type 2B downlink channel access procedure for the DL transmission.

In an embodiment, an energy detection threshold parameter associated with sharing the COT with DL transmissions from the wireless network node to the wireless terminal (e.g., sl-toDL-COT-SharingED-Threshold-r16) is provided. In this embodiment, the wireless network node may transmit, to the wireless terminal, a high layer parameter (e.g., cg-COT-SharingList-r16) associated with a table comprising a row which is configured to indicate that the COT sharing is available or unavailable for at least one of an UL communication or a DL communication.

In an embodiment, the wireless network node receives a COT sharing indication associated with sharing a COT initiated by the wireless terminal from the wireless terminal. Note that the COT sharing indication indicates at least one COT sharing parameter via the table and the at least one COT sharing parameter comprises at least one of an offset associated with starting sharing the COT, a duration of the COT or a channel access priority class of the DL transmission.

In an embodiment, the wireless network node receives a COT sharing indication associated with sharing a COT initiated by the wireless terminal to the wireless network node. In this embodiment, the row in the table indicated by the COT sharing indication indicates that the COT initiated by the wireless terminal is unavailable for communications between the wireless network node and the wireless terminal. Under such conditions, the wireless network node initiates a COT for the communications between the wireless network node and the wireless terminal.

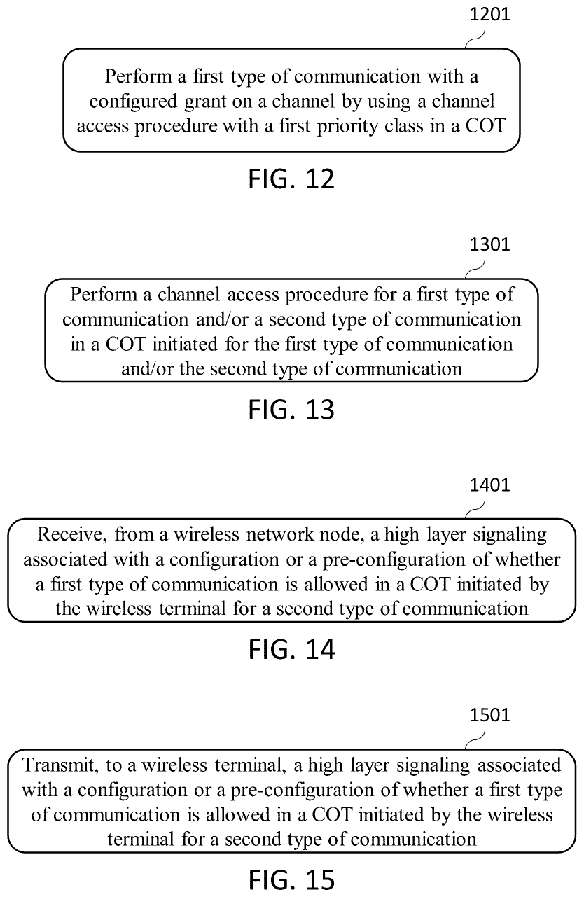

FIG. 12 shows a flowchart of a method according to an embodiment of the present disclosure. The method shown in FIG. 12 may be used in a wireless terminal and comprises the following step:
Step 1201: Perform a first type of communication with a configured grant on a channel by using a channel access procedure with a first priority class in a COT.

In this embodiment, the wireless terminal performs a first type of communication with a configured grant on a channel by using a channel access procedure with a first priority class in a COT.

In an embodiment, the wireless terminal is scheduled to perform a second type of communication on at least part of RBs of the channel following the first type of communication by using a channel access procedure without a CP extension and with a second priority class in the COT. Under such conditions, if the first priority class is greater than or equal to the second priority class and a sum of durations of the first type of communication and the second type of communication does not exceed a COT duration associated with the first priority class, the second type of communication is performed after the first type communication without a gap. If the first priority class is smaller than the second priority class, the first type of communication is terminated on the RBs occupied by the second type of communication.

In an embodiment, the wireless terminal is scheduled to perform a second type of communication on the same carrier of the channel following the first type of communication by using a channel access procedure without a CP extension and with a second priority class in the COT. In this embodiment, if the first priority class is greater than or equal to the second priority class and a sum of durations of the first type of communication and the second type of communication does not exceed a COT duration associated with the first priority class, the wireless terminal performs the second type of communication by following at least one of:
the second type of communication is performed after the first type communication without a gap, or
only the second type of communication is performed when both the first and second communication are scheduled and configured at the same time.

In addition, if the first priority class is smaller than the second priority class, the first type of communication is terminated on RBs occupied by the second type of communication.

Note that the first type of communication is one of an SL communication and a UL communication and the second type of communication is another one of the SL communication and the UL communication.

FIG. 13 shows a flowchart of a method according to an embodiment of the present disclosure. The method shown in FIG. 13 may be used in a wireless terminal and comprises the following step:
Step 1301: Perform a channel access procedure for a first type of communication and/or a second type of communication in a COT initiated for the first type of communication and/or the second type of communication.

In FIG. 13, the wireless terminal performs a channel access procedure for a first type of communication and/or a second type of communication in a COT. The COT is (initiated) for the first type of communication and/or a second type of communication. Under such conditions, at least one channel availability detecting parameter of the channel access procedure is determined based on the at least one channel availability detecting parameter associated with the first type of communication and the at least one channel availability detecting parameter associated with the second type of communication.

In an embodiment, at least one channel availability detecting parameter comprises an energy detection threshold associated with determining an idle status and/or a busy status of a channel. For example, the energy detection threshold of the channel access procedure is set as one of a minimum, an average, or a maximum between the energy detection threshold associated with the first type of communication and the energy detection threshold associated with the second type of communication

In an embodiment, the at least one channel availability detecting parameter comprises a congestion window length associated with determining an availability of a channel. For instance, the congestion window length of the channel access procedure is set as one of a maximum, an average, or a minimum between the congestion window length associated with the first type of communication and the congestion window length associated with the second type of communication.

Note that the first type of communication is one of an SL communication and a UL communication and the second type of communication is another one of the SL communication and the UL communication.

FIG. 14 shows a flowchart of a method according to an embodiment of the present disclosure. The method shown in FIG. 14 may be used in a wireless terminal and comprises the following step:
Step 1401: Receive, from a wireless network node, a high layer signaling associated with a configuration or a pre-configuration of whether a first type of communication is allowed in a COT initiated by the wireless terminal for a second type of communication.

In this embodiment, the wireless terminal receives a high layer signaling associated with a configuration or a pre-configuration of whether a first type of communication is allowed in a channel occupancy time initiated by the wireless terminal for a second type of communication.

In an embodiment, the first type of communications is one of an SL communication and a communication with the wireless network node and the second type of communication is another one of the SL communication and the communication with the wireless network node, wherein the communication with the wireless network node comprises at least one of a UL communication/transmission or a DL communication/transmission.

FIG. 15 shows a flowchart of a method according to an embodiment of the present disclosure. The method shown in FIG. 15 may be used in a wireless network node and comprises the following step:
Step 1501: Transmit, to a wireless terminal, a high layer signaling associated with a configuration or a pre-configuration of whether a first type of communication is allowed in a COT initiated by the wireless terminal for a second type of communication.

In this embodiment, the wireless network node transmits a high layer signaling to a wireless terminal. The higher layer signaling is associated with a configuration or a pre-configuration of whether a first type of communication is allowed in a COT initiated by the wireless terminal for a second type of communication.

In an embodiment, the higher layer signaling recited in FIGS. 14 and/or 15 may also be transmitted to a wireless terminal from another wireless terminal by using, e.g., PC5 RRC signaling or sidelink control information/indicator (SCI) signaling (e.g., first stage SCI, second stage SCI or any other form of SCI). The information in the higher layer signaling in FIGS. 14 and/or 15 can also be transmitted to a wireless terminal from a wireless node by using downlink control information/indicator signaling on downlink control information/indicator signaling (e.g., DCI over either or both of licensed and/or unlicensed spectrum).

In an embodiment, the first type of communications is one of an SL communication and a communication with the wireless network node and the second type of communication is another one of the SL communication and the communication with the wireless network node, wherein the communication with the wireless network node comprises at least one of a UL communication/transmission or a DL communication/transmission.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units: however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
transmitting, to a wireless network node, a channel occupancy time (COT) sharing indication associated with sharing a COT initiated by the wireless terminal,
wherein the COT sharing indication comprises at least one of: a starting point, a duration or an available resource block set of the COT.

2. The wireless communication method of claim 1, wherein the COT sharing indication indicates that the COT is unavailable for transmissions from the wireless network node to the wireless terminal and/or from the wireless terminal to the wireless network node.

3. The wireless communication method of claim 1, wherein the COT sharing indication indicates that the COT is available for communications with the wireless network node,
wherein the method further comprising:
transmitting, to the wireless network node, an indication associated with slots reserved for sidelink (SL) transmissions in the COT.

4. The wireless communication method of claim 3, wherein the indication associated with slots reserved for SL transmissions in the COT comprises at least one of a bitmap associated with slots reserved and/or not reserved for the SL transmissions in the COT, a priority value of each SL transmission in the COT, or a channel access priority class (CAPC) of each SL transmission in the COT.

5. The wireless communication method of claim 3, wherein the wireless terminal performs the SL transmissions in the COT by using a resource allocation mode 2.

6. The wireless communication method of claim 1, wherein at least one of a bitmap associated with slots reserved for SL transmissions in the COT, a priority value of each SL transmission in the COT, or a CAPC of each SL transmission in the COT is not included in the COT sharing indication, and
wherein the wireless terminal performs sidelink transmissions in the COT by using a resource allocation mode 1.

7. A wireless communication method for use in a wireless network node, the method comprising:
receiving, from a wireless terminal, a channel occupancy time (COT) sharing indication associated with sharing a COT initiated by the wireless terminal,
wherein the COT sharing indication comprises at least one of: a starting point, a duration or an available resource block set of the COT.

8. The wireless communication method of claim 7, wherein the COT sharing indication indicates that the COT is unavailable for downlink transmissions from the wireless network node to the wireless terminal and/or from the wireless terminal to the wireless network node.

9. The wireless communication method of claim 7, wherein the COT sharing indication indicates that the COT is available for communications with the wireless network node, wherein the method further comprising:
receiving, from the wireless terminal, an indication associated with slots reserved for sidelink (SL) transmissions in the COT.

10. The wireless communication method of claim 9, wherein the indication associated with slots reserved for SL transmissions in the COT comprises at least one of a bitmap associated with slots reserved and/or not reserved for the sidelink transmissions in the COT, a priority value of each SL transmission in the COT, or a channel access priority class (CAPC) of each SL transmission in the COT.

11. The wireless communication method of claim 9, wherein the wireless terminal performs the SL transmissions in the COT by using a resource allocation mode 2.

12. The wireless communication method of claim 7, wherein at least one of a bitmap associated with slots reserved for sidelink transmissions in the COT, a priority value of each SL transmission in the COT, or a CAPC of each SL transmission in the COT is not included in the COT sharing indication, and
wherein the wireless terminal performs sidelink transmissions in the COT by using a resource allocation mode 1.

13-23. (canceled)

24. A wireless communication method for use in a wireless terminal, the method comprising:
performing a first type of communication with a configured grant on a channel by using a channel access procedure with a first priority class in a channel occupancy time (COT),
wherein a second type of communication on the same carrier of the channel is scheduled to be performed following the first type of communication by using a channel access procedure without a cyclic prefix extension and with a second priority class in the COT,
wherein, if the first priority class is greater than or equal to the second priority class and a sum of durations of the first type of communication and the second type of communication does not exceed a COT duration associated with the first priority class. the second type of communication is performed by following at least one of:
the second type of communication is performed after the first type communication without a gap, or
only the second type of communication is performed when both the first and second types of communication are scheduled and configured at the same time, and
wherein, if the first priority class is smaller than the second priority class, the first type of communication is terminated on resource blocks occupied by the second type of communication.

25. The wireless communication method of claim 24, wherein the first type of communication is one of a sidelink communication and an uplink communication and the second type of communication is another one of the sidelink communication and the uplink communication.

26. A wireless communication method for use in a wireless terminal, the method comprising:
performing a channel access procedure for a first type of communication and/or a second type of communication in a channel occupancy time initiated for the first type of communication and/or the second type of communication,
wherein at least one channel availability detecting parameter of the channel access procedure is determined based on the at least one channel availability detecting parameter associated with the first type of communication and the at least one channel availability detecting parameter associated with the second type of communication.

27. The wireless communication method of claim 26, wherein the at least one channel availability detecting parameter comprises an energy detection threshold associated with determining an idle status and/or a busy status of a channel, and
wherein the energy detection threshold of the channel access procedure is set as one of a minimum, an average, or a maximum between the energy detection threshold associated with the first type of communication and the energy detection threshold associated with the second type of communication.

28. The wireless communication method of claim 26, wherein the at least one channel availability detecting parameter comprises a congestion window length associated with determining an availability of a channel, and
wherein the congestion window length of the channel access procedure is set as one of a maximum, an average, or a minimum between the congestion window length associated with the first type of communication and the congestion window length associated with the second type of communication.

29. The wireless communication method of claim 26, wherein the first type of communication is one of a sidelink communication and an uplink communication and the second type of communication is another one of the sidelink communication and the uplink communication.

30-33. (canceled)

34. A wireless terminal, comprising a memory storing instructions and a processor in communication with the memory, wherein the processor is configured to execute the instructions to implement the wireless communication method according to claim 1.

35-52. (canceled)

53. A wireless terminal. comprising a memory storing instructions and a processor in communication with the memory. wherein the processor is configured to execute the instructions to implement the wireless communication method according to claim 24.
